(19) United States
(12) Patent Application Publication
(10) Pub. No.: US 2013/0299693 A1
(43) Pub. Date: Nov. 14, 2013

(54) TANDEM MASS SPECTROMETRY USING COMPOSITE WAVEFORMS

(71) Applicants: Yu Xia, West Lafayette, IN (US); Frank A. Londry, Omemee (CA)

(72) Inventors: Yu Xia, West Lafayette, IN (US); Frank A. Londry, Omemee (CA)

(21) Appl. No.: 13/877,580

(22) PCT Filed: Oct. 13, 2011
(86) PCT No.: PCT/US11/56103

§ 371 Date: Jul. 30, 2013

Related U.S. Application Data
(60) Provisional application No. 61/392,776, filed on Oct. 13, 2010.

(51) Int. Cl. H01J 49/00

(52) U.S. Cl. CPC H01J 49/004; H01J 49/0031
USPC 250/283; 250/290

(57) ABSTRACT

A tandem mass spectrometer system and method are described, where a composite voltage waveform is applied to so as to trap ion having selected m/z. The trapped ions may be subject to collision induced ionization dissociation (CID) by a selectable discrete frequency voltage waveform positioned so as to be in a notch in a broadband waveform. The resultant ion products may be trapped using a second notch having a center frequency corresponding to the ion product to be trapped. The process may be repeated so as to increase the amount of ions produced, or the process a first resultant ion product to yield a second resultant in product, which may be trapped.

The present application claims the benefit of priority to U.S. provisional application Ser. No. 61/392,776, that was filed on Oct. 13, 2010, and which is incorporated herein in its entirety by reference.

### TECHNICAL FIELD

The present application may relate to an apparatus and method for performing mass spectrometry.

### BACKGROUND

Tandem mass spectrometry, or mass spectrometry/mass spectrometry (MS²) may be used for complex mixture analysis due to its high specificity, wide applicability, and good sensitivity.

Tandem mass spectrometry is a technique in mass spectrometry (MS) to provide both qualitative and quantitative information on the analyte molecules and having a discrimination effectiveness against noise. Noise may be understood as both electronic noise for small signals, and detected signals associated with unwanted molecules. Analysis activities in proteomics, for example, rely heavily on the identification of unknown proteins in complex mixtures using tandem mass spectrometry. In the pharmaceutical industry, reaction monitoring (one type of MS²) is extensively employed to monitor the change of quantity of a selected metabolite as a function of time.

Tandem mass spectrometry comprises: precursor-ion isolation (first stage of MS); reactions that change the mass-to-charge ratio (m/z) of the precursor ions; and, product-ion mass analysis (second stage of MS). The structural information characterizing the analyte is deduced based on the measured product-ion masses, the formation of which is influenced by the method used to induce the change of the m/z of the precursor ions.

A variety of chemical or physical techniques have been employed to alter the m/z of precursor ions. These techniques include collision induced dissociation (CID), ion/photon interaction, ion/electron interaction or reaction, ion/molecule reactions and ion/ion reaction. CID is the most widely used activation method available on a commercial tandem mass spectrometer.

Tandem mass spectrometry techniques can be categorized as “tandem-in-space” or “tandem-in-time.” In the former mode, mass analysis and reactions are performed on a beam of ions during the flight of the ions through the analysis device. Instruments suitable for tandem-in space analysis are typically transmission-type instruments including sectors, triple quadrupole, quadrupole/time-of-flight (TOF), and TOF/TOF. In the tandem-in-time analysis, the steps occur in the same space but follow a time sequence. Such an analysis may be performed in ion trapping mass analyzers such as a quadrupole ion trap, an ion cyclotron ion trap or a hybrid mass spectrometer containing an ion trapping mass analyzer.

Tandem mass spectrometry, or MS², contains two stages of mass analysis. By adding additional stages of reaction and mass analysis, MSⁿ, where n>2, can be performed. MSⁿ (n>2) is typically performed in tandem-in-time ion trapping instruments. Higher orders of tandem mass spectrometry may provide additional structural information, which has been used to study mechanisms of sequential reactions, deduce the structural motif from the analyte ion, or to differentiate structural isomers. MSⁿ (n=12) has been demonstrated on a quadrupole ion trap instrument.

The number of MS stages that can be executed, however, is limited by the number of ions that remain after each ion isolation step. Often, the intensities of the fragment ions within the MSⁿ analysis chain are too low to allow for the performing of MSⁿ analysis.

### SUMMARY

An apparatus and method of performing tandem mass spectrometry is described. The apparatus and method may be arranged such that the ions involved in the MSⁿ analysis chain (e.g., m₁, m₂, . . . mₙ₋₁, wherein mₙ represents a particular ion mass), are isolated and fragmented, while other fragment ions are ejected from an ion trap. By performing a selection of preferred ion masses, the ion type(s) of interest can be accumulated to a higher intensity with a less detrimental effect from the space charge or other artifacts in an ion trap.

The apparatus may be a linear ion trap, or a Paul trap, using a composite excitation voltage waveform. The composite waveform may be an alternating current potential applied to the apparatus, where the broadband waveform contains frequency-domain amplitude notches for isolating one or more of fragment ions of a desired m/z and discrete frequency components to selectively induce collisional activation of these ions. Not all of the masses may be present at the outset. That is, the mass of the ion to be isolated may be derived from the mass of a precursor ion. Once a suitable intensity of the desired isolated ions is reached, the step of tandem mass spectrometry can be performed.

### BRIEF DESCRIPTION OF THE FIGURES

FIG. 1 is a schematic view of a triple-quadrupole/linear ion trap mass spectrometer; and B, is a block diagram of a system using the mass spectrometer;

FIG. 2 is a schematic view of a composite waveform for a MS⁴ experiment;

FIG. 3 is a MS² ion trap CID mass spectrum of a disaccharide;

FIG. 4 is a graph showing characteristics of a composite waveform as used in the experimental example;

FIG. 5 is a MS² ion trap CID mass spectrum of a disaccharide with the application of the composite waveform shown in FIG. 4; and

FIG. 6 is a graph comparing the ion intensity of a MS² product as a function of ion injection time with or without the application of a composite waveform.

### DESCRIPTION

Exemplary embodiments may be better understood with reference to the drawings, but these embodiments are not intended to be of a limiting nature. In the following description, numerous specific details are set forth in order to provide a thorough understanding of the present invention which, however, may be practiced without some or all of these specific details. In other instances, well known process operations have not been described in detail in order not to unnecessarily obscure the description.

The combination of hardware and software to accomplish the tasks described herein is termed a system. Where otherwise not specifically defined, acronyms are given their ordinary meaning in the art.

The processing of a signal may be by either analog or digital circuits, or a combination thereof. The signal processing may be also performed by one or more computers with associated memory and computer code which performs mathematical operations and functions equivalent to that performed by the analog or digital circuits. Herein, there is not intended to be a restriction of the type of circuit which performs each function, or the combination of types of circuits which may be used, although the examples may mention a specific type of circuit in the description thereof.

A software program product for implementing processes or functions of the system, may be provided on computer-readable storage media or memories, such as CD-ROM, hard disk, FLASH memory, or the like, that is a non-transient memory, and may be downloaded to a computer memory and executed by a processor, computer, or the like. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like. In an embodiment, the instructions may be stored on a removable media device for reading by local or remote systems. In other embodiments, the instructions may be stored in a remote location for transfer through a computer network, a local or wide area network or over telephone lines. In yet other embodiments, the instructions are stored within a given computer or system.

While the methods disclosed herein have been described and shown with reference to particular steps performed in a particular order, it will be understood that these steps may be combined, sub-divided, or reordered to from an equivalent method without departing from the teachings herein. Accordingly, unless specifically indicated herein, the order and grouping of steps of the method is not intended to be a limitation.

The operation of a mass spectrometer is well known to persons of skill in the art and is not described in detail. However, in general, a source of ions is provided, such as an electrostatic ion generator (ESI) that introduces ions into the mass spectrometer. The initial quadrupole arrays may serve to perform mass selection on the ions, and to serve as stages for cooling the ions, reaction of the ions with analytes, and isolation between regions of differing pressure. In the example described herein, the proximal source of ions being acted on by Q3 may be reactions or selections made in Q2.

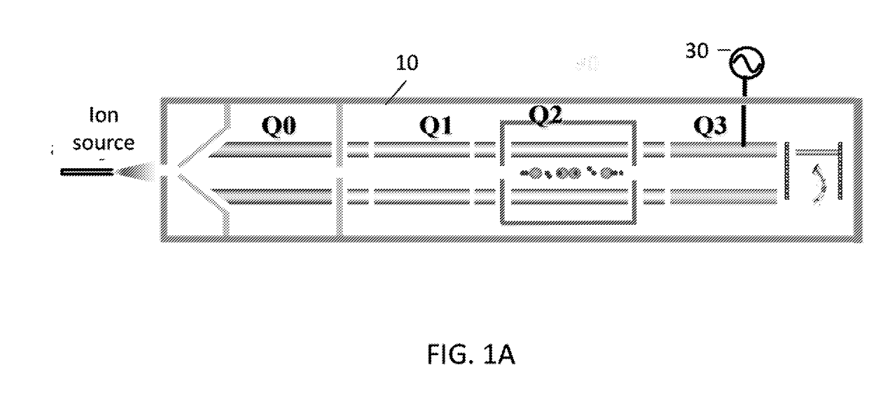

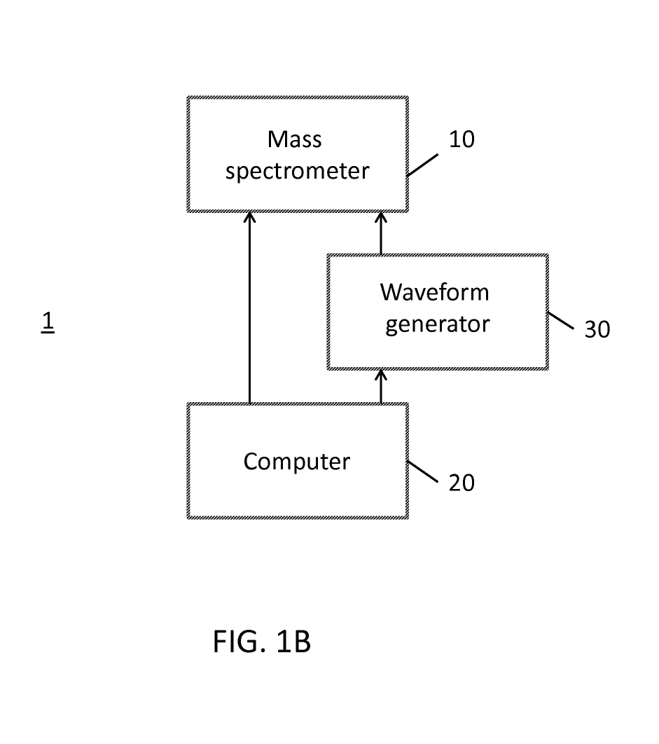

A hybrid linear ion trap mass spectrometer shown schematically in FIG. 1A, such as the commercially available 4000 QTRAP instrument (AB SCIEX Concord, Ontario, Canada) was used to acquire the data presented herein. The instrument has a triple quadrupole configuration Q1, Q2, Q3, where the last quadrupole array (Q3) can also function as a linear ion trap for mass analysis. In this example, the Q3 linear ion trap was used as a mass analyzer to perform tandem-in-time MSⁿ analysis A frequency-notched broadband waveform, or composite waveform, was applied to the Q3 quadrupole array and controlled by a controller, which may be computer executing a stored set of instructions.

The overall system 1, including the mass-spectrometer 10, a control computer 20, which may be a personal computer, workstation, or the like, and a waveform generator 30, which may be, for example, a plurality of waveform generators, a computer synthesizing a waveform, or a stored pattern of amplitude data that is clocked into a digital to analog converter, is shown in FIG. 1B. The components of the system 1 may be separate modules connected by cables or one or more of the components may be combined into a single unit.

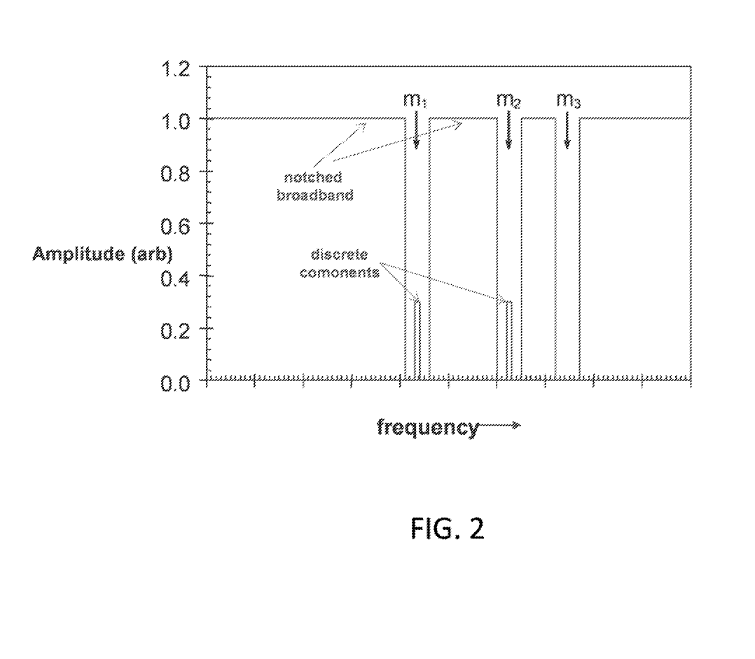

m₁, m₂, and m₃ ions may be isolated by a frequency-notched broadband waveform (shown in FIG. 2), while selected m₁ ions undergo collisional activation due to the applied discrete frequency components. The resultant m₂ ions are accumulated where, in this example, a frequency notch exists, but there is no corresponding discrete frequency waveform.

The m₂ ions may be isolated with higher resolution using the RF/DC mode of operation after the ions are cooled in the ion trap. Another stage of collisional ion dissociation (CID) can be applied to m₂ and MS⁴ data can also be obtained, for example.

The two types of waveforms represented in FIG. 2 may be applied simultaneously or sequentially using a plurality of signal sources, or combined in a single composite waveform during a ion-fill period to accumulate only m₂. Composite waveforms of arbitrary amplitude, frequency and phase characteristics may be generated using a computer controlled waveform generator. Such generators, for example, may comprise a memory having a generated or stored sequence of amplitude values, where the stored sequence of values are output through a digital-to analog converter. The amplitude of the excitation waveform should be chosen sufficiently low that m₁ and m₂ that are being dissociated are not lost by collision with the rods or ejection form the device.

Where the term “broadband (or wideband) waveform” is used an alternating current (AC) signal is meant. This waveform may also be understood by a person of skill in the art to be a “radio frequency” signal. The AC (or RF) signal used to fragment an ion species mₙ may be a single, or discrete, frequency, or may be a signal having a narrower band than the notch in the wideband waveform, or a lower amplitude of signal in the notch region. That is, the amplitude and other characteristics of the signal in the notch region is selected based on the fragmentation process requirements and the amplitude outside of the notch region may be selected on the basis that notch region is being used for isolation, and the remaining regions preferably expel other ions. A plurality of notches in the broadband waveform, and a plurality of discrete frequencies may be provided either simultaneously or sequentially, depending on the specific objectives of the measurements to be performed.

Moreover, a person of skill in the art would understand that the term “broadband” means that the frequency and amplitude of the waveform are selected so as to encompass a range of m/z such that the ions of undesired m/z values are selectively eliminated from the ion trap. A notch in the broadband waveform would be understood to be a reduction in the amplitude of the waveform, so that the effect of the waveform on an ion of a desired m/z is to retain the ion in the ion trap, with or without further dissociation. The amplitude of the waveform in the notch region is selected to either provide further dissociation of the ion, or is sufficiently low as to have little or no effect on dissociation. The width of such a notch may be determined by, amongst other things, the presence of ions having similar m/z ratios, any thermal or other mass spectrum spreading, or the like. In other situations, while the broadband waveform may have a notch in the spectrum, so as to retain or trap, a particular ion, the source ion that is being dissociated may be in a different m/z regime, and a narrowband waveform of appropriate frequency may be synthesized, and the amplitude at that frequency independently adjusted.

A notch may be narrowband, whether it has an amplitude or not, and an independent “discrete” frequency” may be narrowband. The bandwidth of a discrete frequency component may be quite narrow (typically a single frequency), or have a bandwidth sufficient to account for experimental error and convenience, while not affecting any known adjacent ions in the m/z space. The frequency notch may centered around the secular frequency of the ions with a notch width of between about 4 and about 8 kHz, where the notch is not situated at an end of the broadband waveform band.

Herein, the source of the alternating current signal may be termed a “radio frequency generator,” regardless of whether the radio frequency generator is a plurality of signal generators whose outputs are combined, or a computer synthezizer generating a composite waveform, or other technique producing a similar excitation waveform.

A method for using a system, such as that shown in FIG. 1B, for accumulating low abundance MS² ions for MS³ analysis may include the following steps:
1. Fill Q3 with all types of ions from the source or reactions;
2. After the ions have been cooled, isolate m₁ (and m₂ when a multi-step isolation is performed) in Q3 using a RF/DC technique;
3. Allow the isolated ions to cool;
4. Apply a composite waveform which has a broadband waveform component that is notched to isolate m₁ and m₂ and having a single frequency waveform to fragment m₁ so as to produce m₂.
5. Allow the ions to cool.
6. Isolate m₂ in Q3 using a RF/DC technique;
7. Perform CID of m₂ in Q3; and
8. Perform mass analysis.
   Steps 1-6 may be repeated until m₂ has been accumulated in sufficient numbers for analysis if the ion intensity from a single ion injection event is low. Note that isolation in step 2 may be also achieved, for example, using RF/DC.

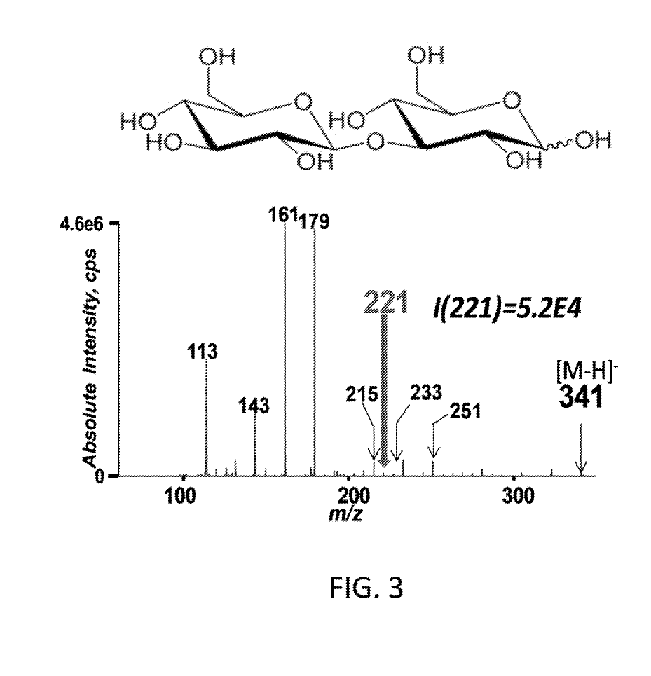

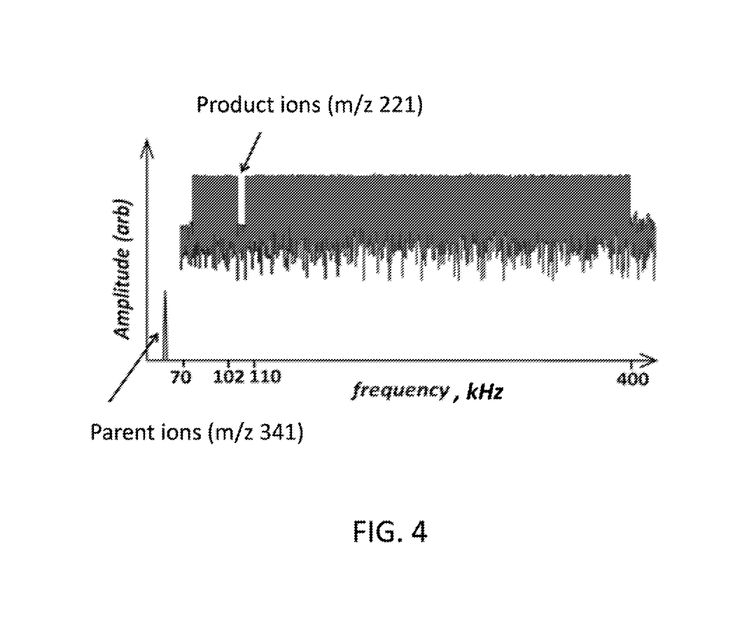

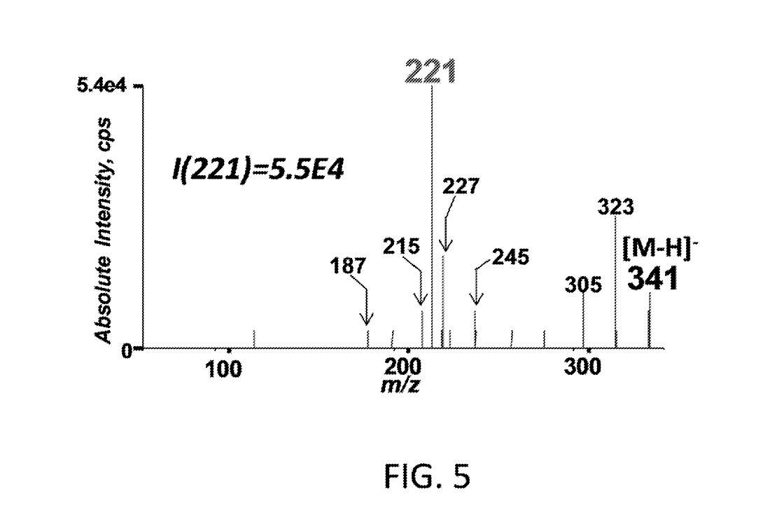

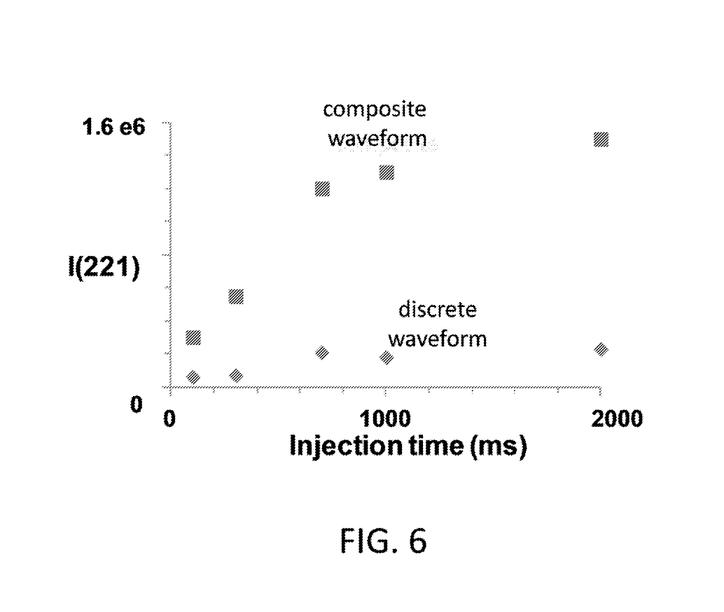

FIG. 3 shows the ion-trap MS²-CID of [M-H]⁻ (m/z 341, m₁) ions of a disaccharide, laminaribiose, after a 50 ms injection time. The product ion of interest is the ion at m/z 221 (m₂). The intensity of the m/z 221 ion is too low, in this example, to acquire good quality data for MS³. FIG. 5 shows that, when a composite waveform (FIG. 4) is applied, the intensities of the fragment ions, e.g., m/z 113, 161, 179, are greatly reduced, while the relative intensity of the m/z 221 ions increases The composite waveform has a discrete frequency (69 kHz) for CID of m/z 341, and a broadband waveform having a notch for m/z 221 The broadband waveform has an effective notch in the region of m/z 341, which may be rather broad as there are no other components of interest in the nearby m/z space. With the application of the composite waveform, there is no loss of m/z 221 ions while the relative intensity of m/z 221 is greatly increased and the absolute intensity may not be reduced either. The intensities of m/z 221 ions (after RC/DC isolation in Q3) are plotted as a function of the injection time (FIG. 6) with and without the composite waveform processing. One may observe that the intensity of m/z 221 ions (squares) are much higher than the intensity that can be obtained with traditional ion-trap CID method (diamonds) at relatively long injection periods (>300 ms), which leads to enhanced sensitivities for MS³ experiments.

The technique may be extended to MSⁿ (n>3), by adding more notches to the isolation waveform, and more components to the fragmentation waveform. This technique may be more effective in the low-pressure environment of Q3 if ions were allowed to thermalize between periods of isolation and fragmentation. However, in a higher pressure environment, such as that of Q2, where ions thermalize more quickly, an n^{th} generation ion may be accumulated by applying both the notched and narrowband waveforms continuously during an extended fill period. This latter approach may be useful on instruments which may not have the ability to repeat a specified range of segments a large number of times.

Although only a few examples of this invention have been described in detail above, those skilled in the art will readily appreciate that many modifications are possible without materially departing from the novel teachings and advantages of the invention. The invention is limited only by the claims and equivalents thereof.

What is claimed is:

1. An apparatus for analyzing ions, comprising:
a mass spectrometer, and
a radio frequency generator,
wherein the radio frequency generator is operated to provide a first RF waveform having a controllable frequency range and an amplitude, and a notch in the frequency range having a controllable frequency and amplitude.

2. The apparatus of claim 1, wherein the radio frequency generator is operated to provide a second RF waveform having a controllable frequency and amplitude.

3. The apparatus of claim 2, wherein the frequency of the second RF waveform is controlled to corresponds to the notch frequency of the first RF waveform.

4. The apparatus of claim 1, wherein the amplitude of the notch in the first RF waveform is selected so as to avoid dissociation of ions present in the portion of the mass spectrometer to which the RF waveform is applied.

5. The apparatus of claim 2, wherein the first RF waveform and the second RF waveform are applied simultaneously.

6. The apparatus of claim 1, wherein the first RF waveform and the second RF waveform are applied sequentially.

7. The apparatus of claim 1, wherein the first RF waveform is a broadband waveform.

8. The apparatus of claims 1 or 7, wherein notch in the first waveform has a bandwidth of between about 4 kHz and about 8 kHz.

9. The apparatus of claims 1, 7 or 8, wherein the signal amplitude in the notch is selected so that ions of an m/z ratio corresponding to the notch frequency are trapped by the mass spectrometer.

10. The apparatus of claims 1, 7, or 8 wherein the signal amplitude in the notch is selected so that ions of an m/z ratio corresponding to the notch frequency are excited so as to produce ions of another m/z ratio that are trapped by another notch having a notch frequency corresponding to the another m/z ratio.

11. The apparatus of claim 1, 2, or 3, wherein the mass spectrometer is a linear ion trap.

12. The apparatus of claim 1, 2, or 3 wherein the mass spectrometer is a Paul trap.

13. The apparatus of claim 1, wherein the mass spectrometer and the waveform generator are controlled by a computer.

14. A method of analyzing a sample, the method comprising:
providing a mass spectrometer;
providing a radio frequency (RF)voltage generator capable of producing a composite voltage waveform;
generating ions from an analyte;
injecting the ions into the mass spectrometer so as to form ions having at least one mass to charge ratio that is a first desired mass to charge ratio (m/z);
operating the RF voltage generator to provide a broadband voltage waveform having controllable upper and lower frequency, and amplitude and controllable frequency notch having a frequency, amplitude and bandwidth so as to eject ions having m/z ratios corresponding to the frequency range of the broadband waveform except for the equivalent m/z ratio of the notch frequency; and
performing mass spectral analysis on ions having another m/z ratio.

15. The method of claim 14, wherein the amplitude of the voltage in the notch is sufficient to cause the ions of the first desired m/z ratio to react with other gaseous components so as to form ions having a second desired m/z ratio, wherein the second m/z ratio corresponds to the notch frequency; and
performing mass spectral analysis on the ions having the second desired m/z ratio.

16. The method of claim 14, wherein the composite voltage waveform includes a narrowband RF waveform having a controllable frequency and amplitude.

17. The method of claim 15, wherein the frequency of the narrowband waveform is selected to correspond to the center of a notch frequency range.

18. The method of claim 16, wherein the amplitude of the narrowband waveform is selected so as to cause a reaction of the ions having first m/z ratio so as to produce ions having another m/z ratio.

19. A computer program product, stored in a non-transient computer readable medium, having instructions so as to cause a computer to perform the steps of:
controlling a radio frequency (RF) voltage generator to produce a composite voltage waveform;
operating a mass spectrometer using the voltage waveform to trap a first ion having a first m/z ratio corresponding to a notch frequency in a broadband waveform produced by the waveform generator;
controlling the amplitude of the broadband waveform amplitude so as to reduce the populations of ions having m/z ratios not corresponding to the notch frequency;
controlling the RF waveform generator so as to produce a discrete frequency waveform having a frequency selected to correspond to a central frequency of a notch;
controlling the RF waveform generator so as to form another notch in the broadband waveform so as to trap an ion having another m/z ratio.
